(19) United States
(12) Patent Application Publication
(10) Pub. No.: US 2025/0205833 A1
(43) Pub. Date: Jun. 26, 2025

(54) ROTARY WELDER

(71) Applicant: Ryan Frumusa, Rochester, NY (US)

(72) Inventor: Ryan Frumusa, Rochester, NY (US)

(21) Appl. No.: 18/970,873

(22) Filed: Dec. 5, 2024

Related U.S. Application Data
(60) Provisional application No. 63/614,641, filed on Dec. 25, 2023.

(51) Int. Cl. B23K 37/04

(52) U.S. Cl. CPC B23K 37/0452

(57) ABSTRACT

A portable rotating welding machine comprising: a base; a housing rotatably attached to the base; a motor assembly contained within the housing; and a welding plate assembly attached to the motor assembly and extending through housing, wherein the welding plate assembly comprises a welding plate attached to a hollow shaft and wherein the hollow shaft attached to the motor assembly and a purge adapter attached to the hollow shaft.

### CROSS-REFERENCE TO RELATED APPLICATIONS

This application is a continuation-in-part (and claims the benefit of priority under 35 USC 120) of U.S. application No. 63/614,641 filed Dec. 25, 2023 is pending. The disclosure of the prior applications is considered part of (and is incorporated by reference in) the disclosure of this application.

### BACKGROUND OF THE INVENTION

The present invention relates to welding machines, and more particularly to a portable work holding apparatus.

Weld positioners are an important component within the welding industry, drastically improving the efficiency and precision of welding operations across various manufacturing sectors. Manipulating the orientation of workpieces during welding processes enhances accessibility and improves weld quality.

Rotary weld positioners, also commonly referred to as a “turntable”, facilitate controlled rotation and positioning of workpieces, which enhances the welder operator's access, maneuverability, and precision during welding operations, especially on round or cylindrical objects. This rotational capability introduces an automation element into the welding process, allowing both human and robotic operators to consistently weld around cylindrical objects without the need for repeated repositioning of themselves or the welding torch. The integration of this technology significantly improves efficiency, safety, and the overall quality of welds, benefiting diverse industries.

As welding technology advances and becomes more accessible, there is a growing demand for supporting equipment and technologies like weld positioners to progress and expand.

While some welding processes necessitate little to no electrical conductivity through a weld subject, such as during laser welding, arc welding processes require the welding current to pass through the object and return to the welding machine. When introducing work holding equipment such as weld positioners into the welding process, this electrical current must then be able to pass through the positioning equipment as well. Consequently, a current-conducting mechanism within the positioner is essential. The welding subject is fixtured in place on a device that rotates it, at a consistent but adjustable speed. Conducting the electrical current used to create welding arcs through a rotating shaft poses several engineering challenges. The conductive mechanism must have no effect on the smooth and controlled rotation of the shaft, withstand high electrical currents and temperatures, and prove to be durable in an industrial setting.

Prior solutions, such as braided cables wound around the rotary shaft, concentrated contact points or brushes, and slip-ring style conductors have been used among others. However, these methods often encounter material stress and design limitations, leading to breakdowns or are highly limited in current-carrying characteristics, which places constraints on welding capabilities. Some of these methods have wear items that breakdown consistently over time due to the friction generated against them as the shaft rotates, which causes them to breakdown or fail, or be subject to a higher frequency of routine maintenance or adjustment. Slip rings typically have many components to them and are expensive to manufacture, especially when built to carry high electrical currents.

Transmission of the high electrical currents typically used in welding processes induces significant heat due to material resistance. This heat contributes to material stress, causing degradation, impeding smooth mechanical rotation, and leading to shaft bearing failure, ultimately reducing the system's ability to carry current efficiently. Thus, managing the heat generated by electrical currents within the mechanism stands pivotal in ensuring optimal performance, longevity, and reliability of the involved components.

Furthermore, beyond the thermal stresses generated by the transmission of high electrical currents, the welding arc itself significantly contributes to heat exposure within the machine. Considering that welding subjects typically possess varying degrees of thermal conductivity; they retain the capacity to conduct heat along the positioner shaft even after the welding arc ceases, such as the shaft itself does as well. This residual heat further compounds the potential for degradation or failure of bearings and current-carrying mechanisms integral to the weld positioner. The foremost bearing supporting the shaft in a rotary positioner, is typically situated closest to the welding subject, and therefore exposed to the greatest magnitude of heat. This foremost bearing thus poses another engineering challenge for rotary weld positioner design.

Bearing styles featuring moving parts, such as ball-bearings and needle-bearings, are particularly susceptible to failure due to their reliance on lubricants. Elevating the temperature of these lubricants outside of their operating range and/or up to their flashpoint (and subsequent combustion), renders the bearing incapable of functioning optimally, leading to compromised shaft rotation smoothness or, in cases of heightened friction, complete bearing failure and seizure. Moreover, in the event of a failure in the current-carrying conductor, the bearing itself may serve as a potential transmission point for welding current. Continuous exposure of lubricated mechanical roller bearings to heat from both welding arcs and the transmission of high electrical currents often culminates in complete bearing failure, resulting in shaft seizure.

It is desired for an apparatus to overcome these issues and allow for a rotary welding positioner that allows for proper conductivity of the electrical current as well as adequate heat dispersion while also having low maintenance requirements.

### SUMMARY

Accordingly, the present invention may be comprised of a base; a housing rotatably attached to the base; a motor assembly positioned within the housing; and a welding plate assembly attached to the motor assembly and extending through housing.

Accordingly, the present invention may be comprised of a base; a housing rotatably attached to the base; a motor assembly housed within the housing; and a welding plate assembly attached to the motor assembly and extending through housing.

Accordingly, the present invention, may be comprised of aa base; a housing rotatably attached to the base; a motor assembly contained within the housing; a hollow shaft having a first end and a second extending through the housing connected to the motor assembly; a welding plate assembly attached to the first end of the hollow shaft hollow shaft; a purge adapter attached to the second end of the hollow shaft; and a bearing pack attached to the hollow shaft.

### BRIEF DESCRIPTION OF THE DRAWINGS

FIG. 1 depicts an isometric view of a work holding apparatus, in accordance with one embodiment of the present invention.

FIG. 2 depicts an isometric view of the work holding apparatus, in accordance with one embodiment of the present invention.

FIG. 3 depicts an isometric view of the work holding apparatus main body portion, in accordance with one embodiment of the present invention.

FIG. 4 depicts an exploded view of the work holding apparatus main body portion, in accordance with one embodiment of the present invention.

FIG. 5 depicts an isometric view of the work holding apparatus base portion, in accordance with one embodiment of the present invention.

FIG. 6 depicts an exploded view of the work holding apparatus base portion, in accordance with one embodiment of the present invention.

FIG. 7 depicts an exploded view of a front bearing pack, in accordance with one embodiment of the present invention.

FIG. 8 depicts an isometric view of the work holding apparatus drive assembly, in accordance with one embodiment of the present invention.

### DETAILED DESCRIPTION OF THE INVENTION

The present invention provides a portable rotary welding machine. This machine provides the advantages of assisting a welder during the process of welding one or more parts by continuously rotating one of the parts that is attached to the machine so that the welder does not need to move. This is important because the welding process needs to be continuous and consistent throughout the weld and having to reposition oneself during this process will likely create weak spots or inconsistencies in the weld. The present invention provides further benefits of portability, as this machine can be setup and adjusted so that it is in the ideal position and location for the welder.

The present device seeks to further enhance the welding current conductor and bolster the durability of the foremost bearing when subjected to high temperatures, all while maintaining optimal rotational smoothness. The enhancements aim to provide increased welding current capacity and elevate duty cycle specifications, thereby enhancing the overall efficiency and capabilities for welding operations. Higher current carrying capability and good thermal control are features that effectively increase the machine's advertised capabilities, which make it more capable for welding thicker materials or higher volume production runs. Notably, these improvements are also expected to substantially enhance the machine's durability and longevity.

The improvement solves both the conductive mechanism and foremost bearing with a single device. The device is an electrically conductive bearing with great thermal conductivity properties and no moving components or lubricants. The integration of a pre-existing dry-running sleeve bearing infused with graphite plugs is installed into a specially designed conductive housing. This transforms the bearing into a dual-purpose component, service as both the primary shaft bearing and the conduit for welding current.

The conductive housing being constructed of aluminum alloy, has great thermal conductivity properties as well, and thus when created with geometric features like a heat-sink, reduces shaft temperatures and effectively reduces wear on sensitive machine components. This innovation significantly enhances the machine's welding current capacity and durability by eliminating traditional liquid or grease lubricants in favor of highly conductive graphite plugs embedded within the sleeve bearing. This conductive bearing apparatus, forming part of a subassembly of components, securely attaches to the machine housing, providing a direct connection point for a cable to carry welding current away and subsequently transmit it back to the welding machine.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. It is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates, which may need to be independently confirmed.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

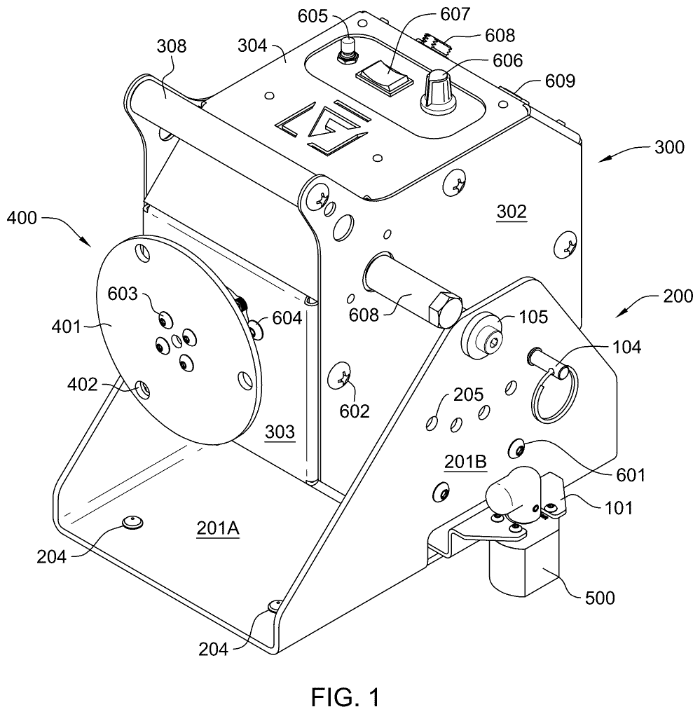

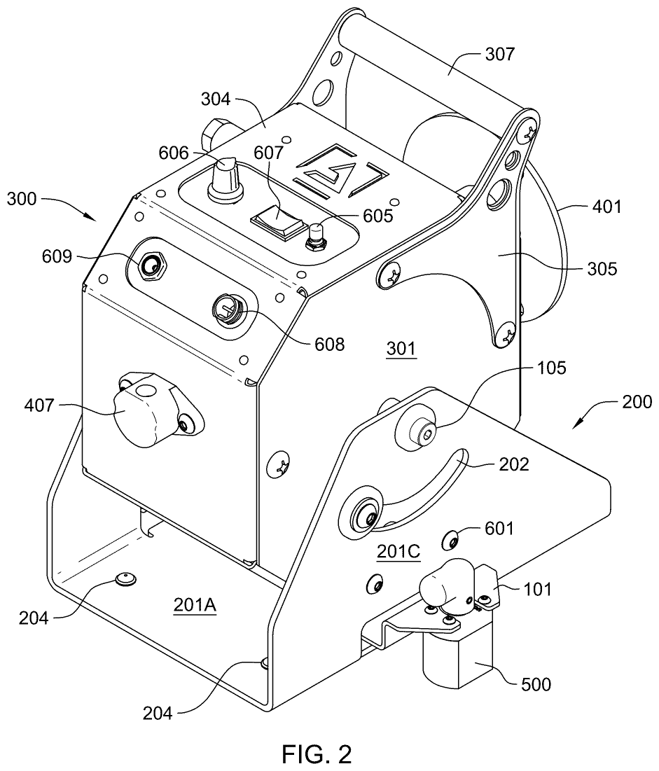

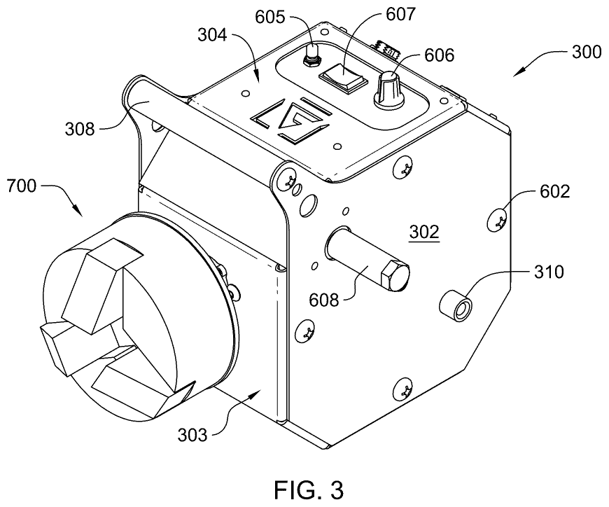

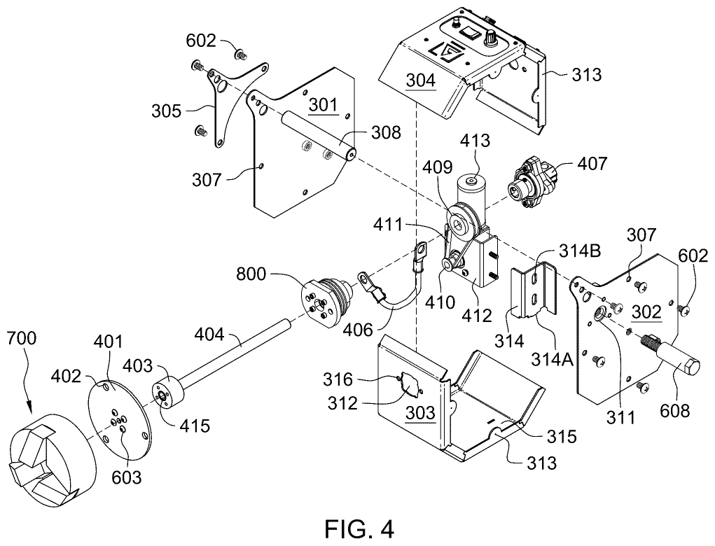

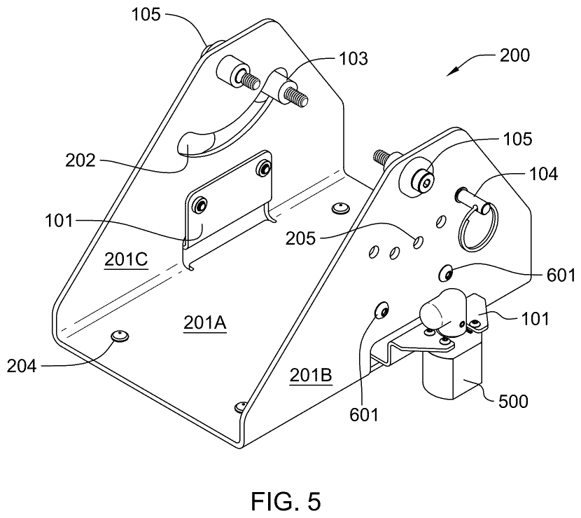

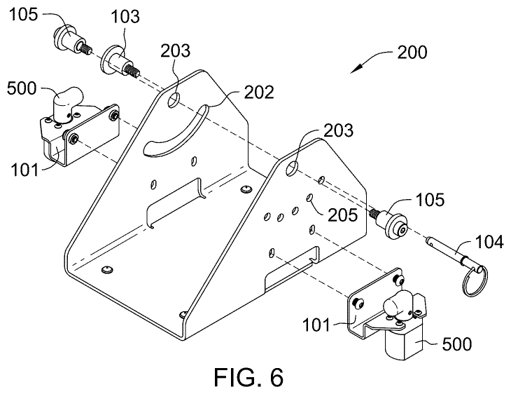

FIGS. 1-6 depict a work holding apparatus 100, in accordance with one embodiment of the present invention. The work holding apparatus 100 is comprised of a base 200, the housing 300, and the rotary assembly 400.

The base 200 is comprised of a C-channel member 201 which provides for the base on which the housing 300 attaches to. The C-channel member 201 is made from steel, aluminum, or other material capable of supporting the housing 300. In the depicted embodiment, sides 201B and 201C have a trapezoidal shape. In additional embodiments, the sides 201B and 201C may have various shapes, or differing shapes based on the design and purpose of the base. On side 201A are a series of openings 204, these openings 204 are to allow for the work holding apparatus 100 to be secured to a surface, to allow for feet to be attached to the work holding apparatus 100, or generally to allow a method to secure the work holding apparatus 100 in place for use.

On side 201B is a slot 206, openings 209, openings 205, and opening 203. The slot 206 is designed to receipt plate 101 with openings 209 to be secured to secure plate 101 to the base 200. Openings 205 are positioned in a pattern at predetermined distances from one another and provide the ability for the housing 300 to be secured at a predetermined position. The opening 205 at predetermined angles allow the welder to know the angle of the housing 300. In the depicted embodiment, openings 205 are a total of five (5) openings which are 22.5-degree increments, but in additional embodiments, more or fewer openings may be present and the angles at which the openings are positioned at may vary. Opening 203 provides the opening for the main securement of the housing 300 to the base 200. A locking pin 104 is inserted through one of the openings 205, and when inserted opening 310 in the housing 300, the housing 300 is secured in said position. Fastener 105 is inserted through opening 203 and rotatably attached to opening 309 of the housing 300, so that the housing may rotate about fastener 105.

On side 201C is a slot 207, openings 208, slot 202, and opening 203. The slot 207 is designed to receipt plate 102 with openings 208 to be secured to secure plate 102 to the base 200. Slot 202 provides for a support for the housing 300, and substantially mirrors the openings 205 on side 201B. Through the use of the alignment bolt 103, the housing 300 is able to rotate through the slot 202, and when the ideal position is found by the welder, they insert the locking in 104 in one of the openings 205. The slot 202 follows the positioning of the openings 205 and is substantially positioned to mirror the openings 205. Opening 203 provides the opening for the main securement of the housing 300 to the base 200. Fastener 105 is inserted through opening 203 and rotatably attached to opening 309 of the housing 300, so that the housing may rotate about fastener 105.

In the depicted embodiment, magnet assemblies 500 are shown attached to plates 101 and 102 respectively. The magnet assemblies 500 are used to secure the work holding apparatus 100 in plate when a magnetic surface is available to be used. The magnet assemblies 500 are positioned to be substantially flush with the bottom surface of the base 200 to allow contact with the surface which is being used. In the depicted embodiment, the magnet assemblies 500 have a rotating member to activate and deactivate the magnet.

In the depicted embodiment, housing 300 is comprised of upper body portion 304, lower body portion 303, and side plates 301 and 302. In various embodiments, the upper body portion 304 and the lower body portion 303 may be comprised of multiple pieces. In the depicted embodiment, the housing 300 members are made from steel. In additional embodiments, various metals such as aluminum or other materials may be used. Side plates 301 and 302 have extensions 306 which provide the attachment point for handle 308. The handle 308 is secured in place with fasteners or the like. Side plates 301 and 302 have openings 307 which align with openings in the upper body portion 304, lower body portion 303 respectively to secure the side plates 301 and 302 to the upper body portion 304, lower body portion 303 using a fastener. Side plate 302 has opening 310 which is positioned to receive the locking pin 104. Side plates 301 and 302 have opening 309 which receives fastener 105 to secure the housing 300 to the base 200. In the depicted embodiment, side plate 301 has attachment 305, wherein the attachment 305 provides an aesthetic purpose to differentiate models of the machine.

Side plate 301 has opening 311 which is sized to receive lug 608. Lug 608 provides for the ground clamp to be attached. Lug 608 has grounding wire 406 attached and secured within the housing 300, and grounding wire 406 is then attached to shaft 404. The grounding wire 406 in one embodiment is a four (4) gauge wire. Lug 608 provides for a ground clamp to be attached to prevent electrical leakage and provide a safe working environment for the welder. The Lug 608 provides the conduit for which the machine passes the current from the welding arc back to the welding machine to complete the current loop.

The upper body portion 304, lower body portion 303 are each comprised of 4 sides, wherein when the housing 300 is constructed, it is an octagon. In additional embodiment, the upper body portion 304, lower body portion 303 may be comprised of varying number of sides or may be separated out into a plurality of sides. The upper body portion 304, lower body portion 303 in the present embodiment is merely one embodiment and is not a limitation on the functional design of the housing 300. The upper body portion 304, lower body portion 303 are welded together. In some embodiments, the upper body portion 304, lower body portion 303 are fastened together.

Lower body portion 303 has opening 312 and openings 316. Opening 312 is sized to receive the front bearing pack 800. Openings 316 are sized to receive a fastener to secure the front bearing pack 800 in place. Lower body portion 303 has a plurality of openings 313 where the side plates 301 and 302 attached and/or fastened to the upper body portion 304 and the lower body portion 303. In some embodiments upper body portion 304, lower body portion 303, and the side plates 301 and 302 are welded together.

The upper body portion 304 has a series of control and attached points to allow for the control work holding apparatus 100. Knob 606 controls the rpm of the shaft 404. In the depicted embodiment the rpm range is 0.3 to 3.3 rpm. In various embodiments, these values may be adjusted or modified based on the intended purpose of the device. Switch 607 controls the direction of the rotation, allowing for both clockwise and counter-clockwise rotation. Button 605 controls the rotation of the rotary assembly 400. The rotation is referred to a “jog” wherein the activation of the button momentarily rotates the rotary assembly 400. In additional embodiments, additional buttons may be present, such as, but not limited to a power button which powers on and off the device, turning the device on and off. In the present embodiment, the button 605 when pressed rotates the shaft 404, and when released the shaft 404 stops rotating. Plug 608 provides for an attachment for a foot pedal (not shown), wherein the foot pedal allows for control of the device and adjustment to the rpm of the shaft 404. In some embodiments, the foot pedal acts similar to button 605, in that when pressed the shaft 404 rotates, and when released the shaft 404, stops. Plug 609 connects the power source (e.g. wall outlet) to provide power to the device. Upper body portion 304 has a plurality of openings 313 where the side plates 301 and 302 attached to the upper body portion 304.

The rotary assembly 400 is comprised of attachment plate 401, shaft 404, front bearing pack 800, motor assembly 408, and purge adapter 407. Attachment plate 401 provides for the surface which the chuck 700 is attached to, to hold the welding subject. The chuck 700 is variable based on the welding subject and is able to be removed and replaced via the fasteners. Attachment plate 401 has a series of openings 409, and a series of openings 402. The openings 402 are for attached the teeth or locking apparatus to hold the welding subject. The openings 409 align with a series of openings 410 of shaft head 403. The attachment plate 401 is then attached to the shaft head 403 via fasteners 603. Shaft head 403 and shaft 404 are a unitary component. The shaft 404 and shaft head 403 have a hollow core 415 throughout the entire component. Shaft 404 is inserted through front bearing pack 800, motor assembly 408 and purge adapter 407.

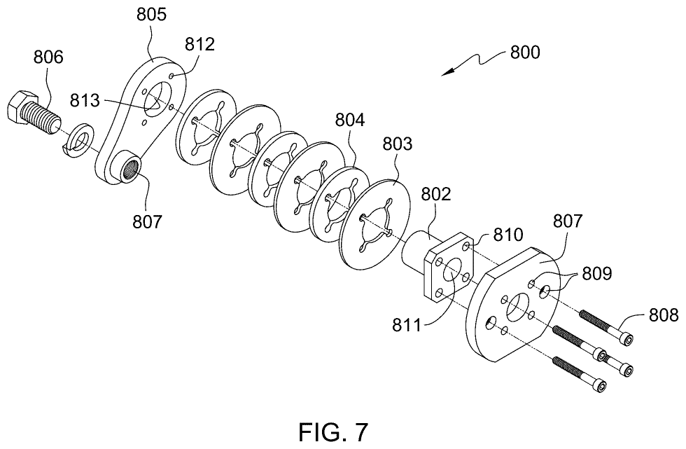

FIG. 7 depicts a front bearing pack 800, in accordance with one embodiment of the present invention. The front bearing pack 800 provides for the completion of the current loop while also being able to withstand the current and allow for the rotation of the attachment plate 401. The front bearing pack 800 is comprised of a front plate 801 which has a set of apertures 809 to receive fasteners 808. Sleeve bearing 802 has a hollow cylindrical section and a flat plate portion that are secured together as a unitary component. The flat plate portion has a series of apertures 810 to receive the fasteners 808 and a central aperture 811 which extends through the hollow cylindrical section. The cylindrical portion is of a predetermined interior and exterior diameters, wherein the interior diameter is sized to receive shaft 404. The exterior diameter is sized to receive the heatsink plates 803 and the spacer plates 804. In one embodiment, the sleeve bearing 802 is made from a graphite plugged bronze. The heatsink plates 803 are disks of a predetermined diameter, thickness, and material based on the heat dissipation requirements of the machine. The spacer plates 804 are of a predetermined diameter, thickness, and material based on the heat dissipation requirements of the machine. The number and order of the heatsink plates 803 and the spacer plates 804 is predetermined and based on the length of the sleeve bearing 802 cylindrical portion. A bearing ground plate 805 is secured to the assembly by fasteners 808 which are secured in apertures 812. A central aperture 813 is sized to fit on the cylindrical portion of the sleeve bearing 802. The bearing ground plate 805 has an aperture 807 distal to the central aperture 813 that is threaded and sized to receive a fastener 806. This fastener 806 interfaces with the grounding wire 406, and the ground wire 406 is then attached to lug 608.

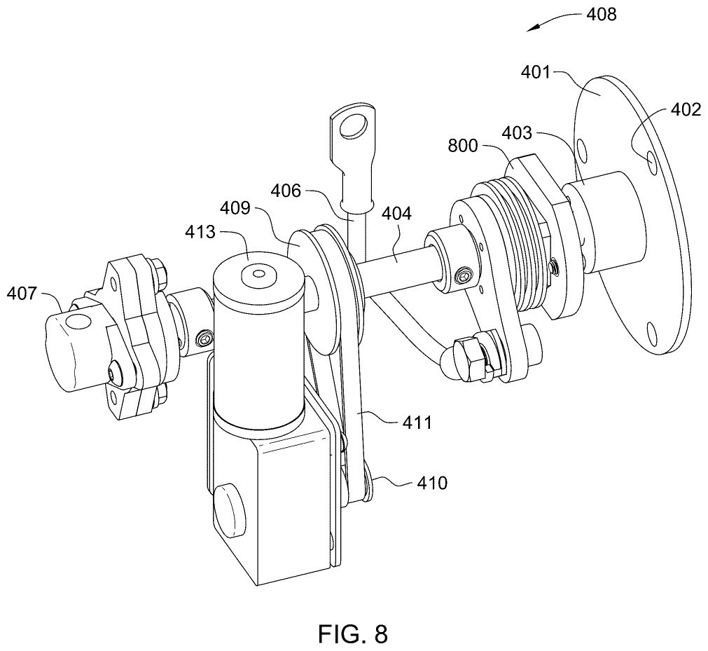

FIG. 8 depicts the motor assembly 408 provides the rotational power of the welding subject. In the depicted embodiment, the motor 413 is a brushless drive motor that provides for continuous smooth rotation. The motor 413 may be a variety of motors that provide the adequate rotational direction, rotations per minute (RPM), and power rating. Attached to the motor 413 is a first pulley 410, which is connected to a second pulley 409 via a belt 411. The second pulley 409 has a central opening which is able to receive the shaft 404. The motor 413 is attached to plate 412. The motor assembly 408 is electrically attached to the various buttons and switches which control the speed and rotational direction of the motor 413. The motor assembly 408 is designed and capable of providing the rpms and bi-directional movement. In the depicted embodiment, the motor assembly 408 requires an external power source. In some embodiments, the motor assembly 408 may have an internal power source. The motor assembly 408 is secured to plate 314 via fasteners which are inserted through slots 314A and 314B which is then secured to the lower body portion 303 (via opening 315), so that the motor assembly 408 is secured in a set position and location, so that all components are properly aligns and operate correctly. In some embodiments plate 314 is welded to lower body portion 303. The motor assembly 408 is connected to knob 606, switch 607, button 605, plug 607, and plug 609. Knob 606 controls the speed control circuitry that allows a user to adjust the motor 413 speed. The control of the motor 413 speed, is done in one embodiment, by pulsing electrical current to the motor 413 at predetermined frequencies and duty cycles to match specific rotational speeds (e.g. RPM). The purge adapter 407 allows for the purging of oxygen and maintaining the purity of the inside of a hollow welding subject (particularly nonferrous metals) to keep the hollow welding subject surface inert and maintain the quality of the material all the way through and maintain the integrity of the weld. The purge adapter is mechanically connected to the shaft 404 and allows for the purging of various gases (such as argon) through the hollow core of the shaft 404. The purge adapter 407 may have additional hoses attached to further remove the gases farther away from the work holding apparatus 100.

The work holding apparatus 100 various parts and components may be made from, but not limited to polyethylene, polyethylene terephthalate, high-density polyethylene, polypropylene, polystyrene, polyvinyl chloride, polyurethane, poly carbonate, polybutylene terephthalate, acrylonitrile styrene acrylate, acrylics, aluminum, steel, cooper, various other metals, a combination of plastics and metals, or the like, expect where parts need to be able to transfer electrically, in which these parts are made from a material which allows for this property.

While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes may be made without departing from the spirit and scope of this invention.

While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes may be made without departing from the spirit and scope of this invention.

It will be further understood that various changes in the details, materials, and arrangements of the parts which have been described and illustrated in order to explain the nature of this invention may be made by those skilled in the art without departing from the scope of the invention as expressed in the following claims.

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

The foregoing descriptions of various embodiments have been presented only for purposes of illustration and description. They are not intended to be exhaustive or to limit the present invention to the forms disclosed. Accordingly, many modifications and variations of the present invention are possible in light of the above teachings will be apparent to practitioners skilled in the art. Additionally, the above disclosure is not intended to limit the present invention. In the specification and claims the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises”.

Although various representative embodiments of this invention have been described above with a certain degree of particularity, those skilled in the art could make numerous alterations to the disclosed embodiments without departing from the spirit or scope of the inventive subject matter set forth in the specification and claims. Joinder references (e.g., attached, adhered, joined) are to be construed broadly and may include intermediate members between a connection of elements and relative movement between elements. As such, joinder references do not necessarily infer that two elements are directly connected and in fixed relation to each other. Moreover, network connection references are to be construed broadly and may include intermediate members or devices between network connections of elements. As such, network connection references do not necessarily infer that two elements are in direct communication with each other. In some instances, in methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

Although the present invention has been described with reference to the embodiments outlined above, various alternatives, modifications, variations, improvements and/or substantial equivalents, whether known or that are or may be presently foreseen, may become apparent to those having at least ordinary skill in the art. Listing the steps of a method in a certain order does not constitute any limitation on the order of the steps of the method. Accordingly, the embodiments of the invention set forth above are intended to be illustrative, not limiting. Persons skilled in the art will recognize that changes may be made in form and detail without departing from the spirit and scope of the invention. Therefore, the invention is intended to embrace all known or earlier developed alternatives, modifications, variations, improvements and/or substantial equivalents.

What is claimed is:

1. A work holding apparatus for welding comprising:
a base;
a housing rotatably attached to the base;
a motor assembly positioned within the housing; and
a welding plate assembly attached to the motor assembly and extending through housing.

2. The work holding apparatus for welding of claim 1, wherein the welding plate assembly comprises a welding plate attached to a hollow shaft and wherein the hollow shaft attached to the motor assembly.

3. The work holding apparatus for welding of claim 1, further comprising, a purge adapter attached to the hollow shaft.

4. The work holding apparatus for welding of claim 1, wherein the motor assembly is able to rotate clockwise and counterclockwise.

5. The work holding apparatus for welding of claim 1, wherein the base has a series of openings at predetermined positions and a locking mechanism is able to secure the housing at each of the predetermined positions.

6. The work holding apparatus for welding of claim 1, wherein the housing has a handle positioned above the welding plate.

7. The work holding apparatus for welding of claim 1, wherein a plurality of controls are accessible on the housing, and the plurality of controls are electrically and mechanically connected to the motor assembly.

8. The work holding apparatus for welding of claim 1, further comprising a ground contact bar which is electrically connected to the hollow shaft.

9. The work holding apparatus for welding of claim 8, further comprising a bearing pack attached to the motor assembly and attached to the ground contact bar.

10. A portable rotating welding machine comprising:
a base;
a housing rotatably attached to the base;
a motor assembly housed within the housing; and
a welding plate assembly attached to the motor assembly and extending through housing.

11. The portable rotating welding machine of claim 10, further comprising a hollow shaft connected to the welding plate assembly at a first end and the motor assembly.

12. The portable rotating welding machine of claim 11, further comprising a purge adapter connected to the hollow shaft at a second end.

13. The portable rotating welding machine of claim 12, further comprising a bearing pack assembly attached to the hollow shaft distal to the first end.

14. The portable rotating welding machine of claim 13, further comprising a grounding lug attached to the housing, wherein the grounding lug is electrically connected to the bearing pack.

15. The portable rotating welding machine of claim 11, wherein the motor assembly is able to rotate counterclockwise and clock wise at a controlled rotation per minute.

16. A portable rotating welding machine comprising:
a base;
a housing rotatably attached to the base;
a motor assembly contained within the housing;
a hollow shaft having a first end and a second extending through the housing connected to the motor assembly;
a welding plate assembly attached to the first end of the hollow shaft hollow shaft;
a purge adapter attached to the second end of the hollow shaft; and
a bearing pack attached to the hollow shaft.

17. The portable rotating welding machine of claim 16, further comprising a grounding lug attached to the housing and the bearing pack.

18. The portable rotating welding machine of claim 16, wherein the bearing pack is comprised of a series of disks.

19. The portable rotating welding machine of claim 16, wherein a plurality of controls are accessible on the housing.

20. The portable rotating welding machine of claim 16, further comprising a locking mechanism to secure the housing at a predetermined position to the base.
